(19) United States
(12) Patent Application Publication
(10) Pub. No.: US 2016/0167553 A1
(43) Pub. Date: Jun. 16, 2016

(54) SEAT COVER AND VEHICLE SEAT

(71) Applicant: TACHI-S CO., LTD., Tokyo (JP)

(72) Inventors: Kengo KATAOKA, Tokyo (JP); Yuhei CHINOMI, Tokyo (JP)

(21) Appl. No.: 14/969,219

(22) Filed: Dec. 15, 2015

(30) Foreign Application Priority Data
Dec. 16, 2014 (JP) 2014-254064

(51) Int. Cl. B60N 2/58

(52) U.S. Cl. CPC B60N 2/5816

(57) ABSTRACT

A seat cover, to be mounted on a seat while covering the frame of the seat, includes: a contact portion contactable with the frame; and a deforming section configured to be collapsed by contacting with the frame, the deforming section being provided at a first surface of the contact portion, the first surface being opposed to the frame.

### CROSS-REFERENCE TO RELATED APPLICATION(S)

This application is based upon and claims the benefit of priority from Japanese Patent Application No. 2014-254064, filed on Dec. 16, 2014, the entire contents of which are incorporated herein by reference.

### BACKGROUND

1. Field of the Invention

The invention relates to a seat cover and a vehicle seat.

2. Description of the Related Art

JP-A-H07-52717 discloses a seat cover which, in a reclining seat with a tiltable seat back, is mounted on a seat cushion while covering a reclining apparatus and a frame. On such inner surface of a cover as is opposed to the reclining apparatus and frame, there are provided multiple ribs and, with the ribs contacted with the frame of the seat, the cover is fastened to the frame.

JP-A-2014-34253 discloses a seat cover which is mounted on the lower surface portion of a seat cushion while covering a rear frame constituted of the two upper and lower pipes connecting together a pair of right and left side frames of the seat cushion. On such inner surface of the cover as is opposed to the rear frame, there are provided multiple arc-shaped first ribs engageable with the upper pipe, and multiple second ribs supporting the lower pipe from below; and, while the second ribs are contacted with the lower pipe, and the upper pipe is engaged with the first ribs, the cover is mounted on the frame.

Generally, a seat cover is formed of resin. The seat covers disclosed in JP-A-H07-52717 and JP-A-2014-34253 are both mounted on the seat in such a manner that the ribs provided on the inner surface of the cover are contacted with the frame of the seat. However, for example, there is a fear that a gap can be produced between some of the ribs and frame due to a molding error or the like caused by resin sink.

When a gap between the frame and ribs to be contacted with the frame is existed, there is a fear that the cover can provide backlash against the frame and thus hitting, noise can be produced by collision between the ribs and frame. Particularly, in a seat such as a vehicle seat easy to produce vibrations, there increases a possibility that hitting noise can be produced due to such vibrations.

### SUMMARY

The invention is made in view of the above-mentioned circumstances and thus has an object to restrict the backlash of the seat cover against the frame to thereby reduce hitting noise.

The invention provides a seat cover, to be mounted on a seat while covering the frame of the seat, including: a contact portion contactable with the frame; and a deforming section configured to be collapsed by contacting with the frame, the deforming section being provided at a first surface of the contact portion, the first surface being opposed to the frame.

The invention also provides a vehicle seat with the above-mentioned seat cover mounted thereon.

According to the invention, the backlash of the seat cover against the frame can be restricted to thereby reduce hitting noise.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a structure view of an example of a vehicle seat, explaining an embodiment of the invention;

FIG. 2 is a structure view of a seat cover of the vehicle seat of FIG. 1;

FIG. 3 is a structure view of an example of a contact portion of the seat cover of FIG. 2;

FIG. 4 is a view, to show the state of the contact portion of FIG. 3 when the seat cover is mounted on the vehicle seat;

FIG. 5 is a structure view of other example of the contact portion of the seat cover of FIG. 2;

FIG. 6 is an enlarged view of a portion surrounded by the broken line circle VI of FIG. 5;

FIG. 7 is a view to show the state of the contact portion of FIG. 5 when the seat cover is mounted on the vehicle seat;

FIG. 8 is a structure view of a modification of the contact portion of FIG. 5; and

FIG. 9 is a view to show the state of the contact portion of FIG. 8 when the seat cover is mounted on the vehicle seat.

### DETAILED DESCRIPTION OF THE INVENTION

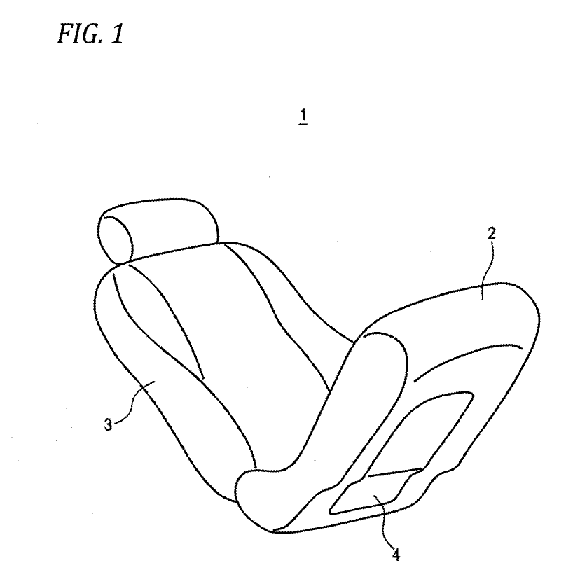

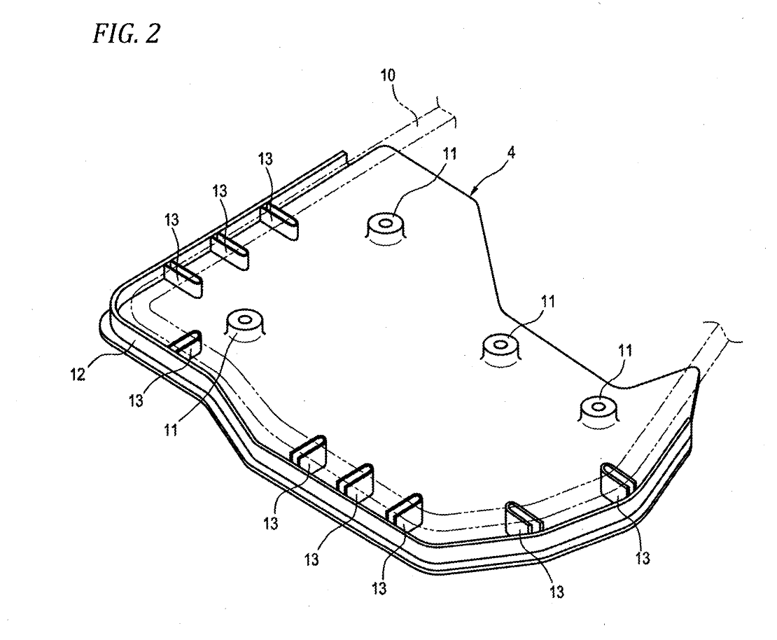

FIGS. 1 and 2 show the structure of an example of a vehicle seat, explaining an embodiment of the invention.

A vehicle seat 1 shown in FIG. 1 includes a seat cushion 2 constituting a seat surface portion and a seat back 3 constituting a back rest portion. The seat cushion 2 and seat back 3 respectively include cushion pads formed of foaming material such as urethane form, and frames for supporting the cushion pads, while the cushion pad and frame are properly coated with skin material such vinyl chloride.

The vehicle seat 1 further includes a seat cover to be mounted on the seat while covering the frame of the seat. In the illustrated example, the seat cover 4 is mounted on the bottom surface of the seat cushion 2 while covering the frame thereof.

FIG. 2 shows the structure of the seat cover 4.

The seat cover 4 is formed of resin and has a panel-like shape so sized as to project at least partially outwardly of the frame 10 of the frame-shaped seat cushion 2.

The seat cover 4 includes multiple fixing portions 11 dispersed in the respective portions thereof. The fixing portions 11 are fixed to the frame 10 and the structure member of the seat cushion 2 mounted integrally on the frame 10 by a proper method such as by a fastening method, whereby the seat cover 4 is mounted on the bottom surface portion of the seat cushion 2.

The seat cover 4 includes, on its inner surface opposed to the frame 10, a frame-shaped side wall portion 12 extending along the edge of the seat cover 4 and multiple contact portions 13 situated inside the side wall portion 12 and arranged along the side wall portion 12 at intervals.

When the seat cover 4 is mounted on the bottom surface of the seat cushion 2, the seat cover 4 stores the frame 10 inside the side wall portion 12 to cover the frame 10 and brings the multiple contact portions 13 disposed inside the side wall portion 12 into contact with the frame 10.

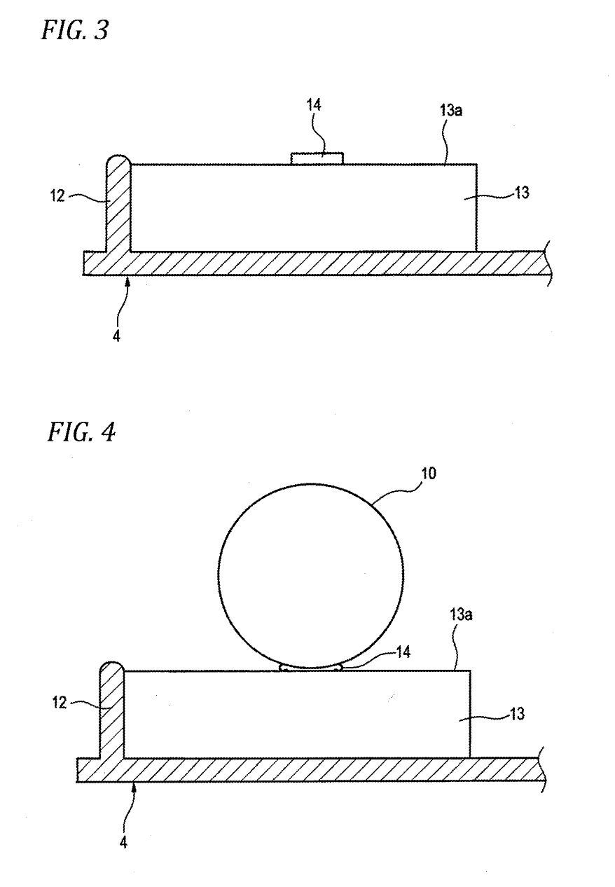

FIG. 3 shows the structure of an example of the contact portion 13.

On such surface 13a of the contact portion 13 as is opposed to the frame 10, there is formed a deforming section 14 collapsible due to contact with the frame 10.

The contact portion 13, in the illustrated example, is formed in a rib-like (plate-like) shape and is erected on the inner surface of the seat cover 4, while the edge surface of the contact portion 13 serves as the opposed surface 13 to the frame 10.

The deforming section 14 is constituted of a projecting section formed on the opposed surface 13a and, in the illustrated example, it is constituted of a piece-shaped projection extending along the edge of the contact portion 13.

The deforming section 14 providing the projecting section on the opposed surface 13a is not supported on the lateral side thereof crossing the projecting direction but, in the periphery of the deforming section 14, there is formed an escape location for material constituting the deforming section 14. This enables relatively easy deformation and collapse of the deforming section 14 when it is contacted with the frame 10.

As the seat cover 4 is mounted onto the cushion 2, the contact portions 13 are respectively contacted with the frame 10 and, as shown in FIG. 4, the respective deforming sections 14 of the contact portions 13 are properly collapsed due to contact with the frame 10, whereby the respective contact portions 13 and frame 10 are closely contacted with each other. This restricts the backlash of the seat cover 4 against the frame 10, thereby reducing hitting noise caused by collision between the contact portions 13 and frame 10.

Here, the contact portion 13 may be formed at least one on the seat cover 4 and the shape of the contact portion 13 is not limited to the rib shape but may be, for example, a boss shape (cylindrical shape). The deforming section 14 is not limited to a special shape so long as it is collapsible due to contact with the frame 10. For example, it may be a dot-shaped projection, or multiple deforming sections 14 may also be formed in the respective contact portions 13.

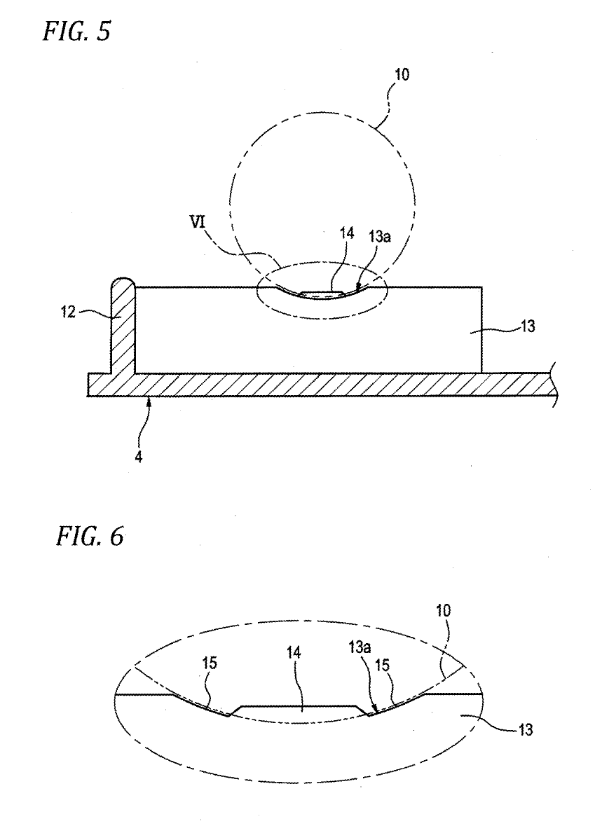

FIGS. 5 and 6 show the structure of other example of the contact portion 13.

In the example of FIGS. 5 and 6, the opposed surface 13a of the contact portion 13 opposed to the frame 10 is formed in a recess shape capable of storing at least part of the frame 10. In the illustrated example, the outer shape of the section of the frame 10 is substantially circular, while the opposed surface 13a is formed in a substantially arc-like shape following the outer shape of the section of the frame 10.

The deforming section 14 is formed in the bottom of the recess-shaped contact portion 13 and further, in the bottom of the recess-shaped contact portion 13, there are formed a pair of recesses 15 along the edge of the contact portion 13 with the deforming section 14 interposed between them. The deforming section 14, due to interposition between the paired recesses 15, provides a projecting section relative to the recesses 15. The deforming section 14 providing the projecting section, as described above, can be collapsed relatively easily due to contact with the frame 10.

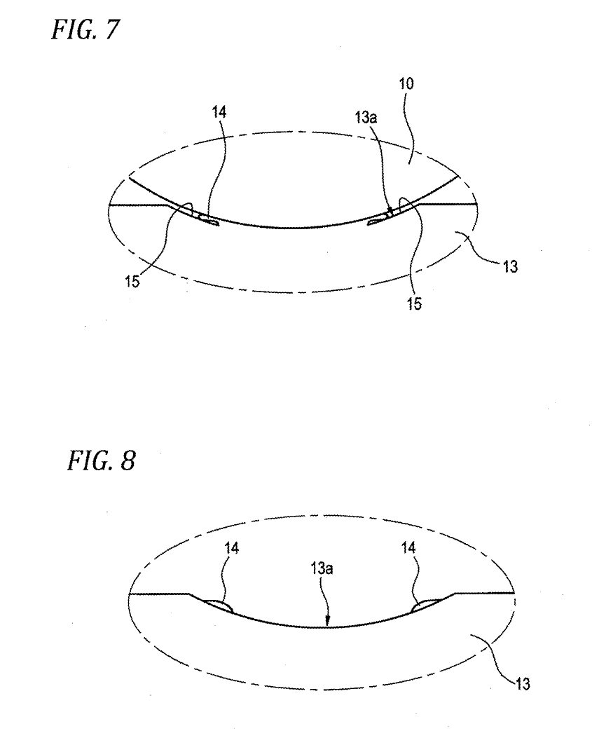

As the seat cover 4 is mounted onto the seat cushion 2, the contact portions 13 are relatively contacted with the frame 10 and, as shown in FIG. 7, the deforming sections 14 of the contact portions 13 are respectively collapsed properly due to contact with the frame 10, whereby the respective contact portions 13 are closely contacted with the frame 10. This restricts the backlash of the seat cover 4 against the frame 10, thereby reducing hitting noise caused by collision between the contact portions 13 and frame 10.

In this example, the opposed surface 13a is formed in a recess shape and at least part of the frame 10 is stored in a recess formed by the opposed surface 13a, thereby enhancing stability of the frame 10 in the contact portions 13. Further, since material constituting the collapsed deforming sections 14 is escaped into recesses 15 formed adjacent to the deforming sections 14 and the recesses 15 are filled therewith along the outer shape of the frame 10, stability of the frame 10 in the contact portions 13 can be enhanced further. Thus, backlash of the seat cover 4 against the frame 10 can be restricted further.

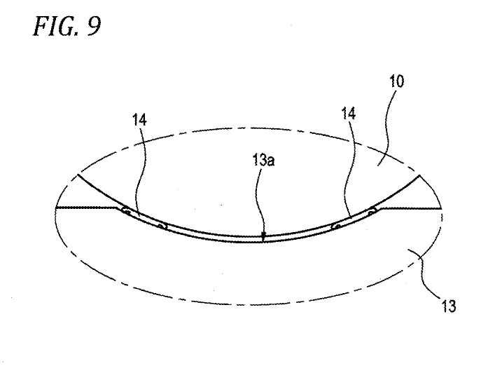

The forming positions of the deforming sections 14 in the opposed surface 13a formed in a recess shape are not limited to the bottom. For example, as shown in FIGS. 8 and 9, the deforming sections 14 may also be formed in the open side end of the recess-shaped opposed surface 13a. In this case, the deforming sections 14 may preferably be formed in both of the two ends of the opposed surface 13a.

The above-mentioned structures of the vehicle seat 1 and seat cover 4 are illustrative and proper deformations and changes are possible without departing from the subject matter of the invention.

The invention has been described with reference to the seat cover 4 to be mounted on the bottom surface of the seat cushion 2. However, the invention can also apply to, for example, a seat cover to be mounted on the back surface of the seat back 3 and a seat cover to be mounted on the side surface of a seat cushion 2 in the reclining seat.

As described above, the seat cover disclosed in this specification is a seat cover which is mounted on the seat while covering the frame of the seat, and includes the contact portions contactable with the frame, while, in the respective opposed surfaces of the contact portions, there are formed the deforming sections collapsible due to contact with the frame.

Also, in the seat cover disclosed in this specification, the deforming sections are projecting sections formed on the opposed surfaces of the contact portions.

In the seat cover disclosed in this specification, the opposed surfaces of the contact portions are respectively formed in a recess-like shape for storing therein at least part of the frame.

In the seat cover disclosed in this specification, the contact portions are respectively formed in a plate-like shape, the opposed surfaces of the contact portions are constituted of the edge surfaces of the contact portions and, in the opposed surfaces of the contact portions, there are formed the deforming sections and the paired recesses arranged along the edges of the contact portions with the deforming sections between them.

The vehicle seat disclosed in this specification mounts the seat cover thereon.

What is claimed is:

1. A seat cover to be mounted on a seat while covering a frame of the seat, comprising:
a contact portion contactable with the frame: and
a deforming section configured to be collapsed by contacting with the frame, the deforming section being provided at a first surface of the contact portion, the first surface being opposed to the frame.

2. The seat cover according to claim 1, wherein
the deforming section is a projecting section formed in the first surface of the contact portion.

3. The seat cover according to claim 2, wherein
the first surface of the contact portion is formed in a recess-like shape for storing at least part of the frame.

4. The seat cover according to claim 3, wherein:
the contact portion is formed in a plate-like shape, the first surface of the contact portion is constituted of the edge surface of the contact portion; and
the first surface of the contact portion includes a pair of recesses arranged along the edge of the contact portion with the deforming section between them.

5. A vehicle seat comprising:
a frame: and
a seat cover including: a contact portion contactable with the frame; and a deforming section configured to be collapsed by contacting with the frame, the deforming section being provided at a first surface of the contact portion, the first surface being opposed to the frame, wherein
the seat cover is mounted on the frame.
